(19) United States
(12) Patent Application Publication
(10) Pub. No.: US 2003/0054148 A1
(43) Pub. Date: Mar. 20, 2003

(54) Composite shingle

(76) Inventor: Randal J. Jolitz, Joplin, MO (US)

Correspondence Address: Christopher R. Benson, Howrey Simon Arnold & White, LLP, 750 Bering Drive, Houston, TX, 77057-2198, US

(21) Appl. No.: 09/865,403

(22) Filed: May 25, 2001

(51) Int. Cl. E04C 1/00; B32B 1/00

(52) U.S. Cl. 428/220

(57) ABSTRACT

Disclosed is a composite roofing shingle. The preferred roofing shingle includes a mixture of a polymer and a filler. The preferred blend includes between about 35-65% polyethylene and 50-70% crushed limestone filler.

### BACKGROUND

1. Field of the Invention

The present invention relates to roofing shingles. Specifically, the present invention relates to composite roofing shingles composed primarily or exclusively of a polyolefin polymer and a filler.

2. Background of the Invention

Traditional roofing products include asphalt shingles, wood shakes, slates, and metal panels. Each of these products has benefits. For instance, wood shakes and slate roofing are very aesthetic. However, wood shakes are considered a fire hazard and slate is very expensive and subject to cracking.

Less expensive roofing products have been introduced to simulate wood shakes and slate roofing. Some asphalt shingles have been developed that resemble slate or shake roofing. However, asphalt products typically do not have the structural rigidity of slate or shake. Metal and plastic shingles have been developed that simulate shake and slate. However, those products are subject to denting and breakage.

Composite shingles are typically composed of an organic/polymer component and a filler component. The composition may be molded to simulate the shape and appearance of various types of roofing including shakes or slates. The amount of polymer in these composite shingles is substantially less than the amount of filler. For instance, U.S. Pat. No. 5,711,126 discloses that the amount of polymer in the composite to range from 12 to 35% and the preferred amount of filler ranges from 65 to 88%.

Although these composite shingles are capable roofing systems, there are some problems. For instance, the large amount of filler causes the product to be excessively heavy while the low amount of polymer reduces flexibility and increases the possibility of cracking and splitting. Accordingly, a need exists to improve composite shingles.

### SUMMARY OF THE INVENTION

The present invention comprises a composite roofing shingle composed primarily of a mixture of a polyolefin based polymer composition and a filler. The blend includes 70-35% polymer and 30-65% filler. The preferred mineral is crushed limestone and the preferred polymer is polyethylene. The shingles may be molded to simulate the appearance of traditional roofing or any other configuration that may be advantageous for a particular roofing application.

### BRIEF DESCRIPTION OF DRAWINGS

FIG. 1 is an isometric environmental view of the preferred roofing material as assembled on a roof.

FIG. 2 is an isometric view of a preferred single piece of roofing material.

### DESCRIPTION OF PREFERRED EMBODIMENT

The preferred roofing system is shown in FIGS. 1 and 2. The preferred shingles are composed of a mixture including a polymer and an inorganic. Colorants and other additives may be used to improve or alter the aesthetics or performance of the shingles. Nevertheless, the preferred composition includes a polyolefin and an inorganic filler.

The polymer component is a polyolefin such as polyethelene, polypropelene or mixture of polyolefin polymers. Preferably, this component is polyethelene. The preferred range of this component is 35 to 70% of the composition by weight.

The filler material may include any number or combinations of materials. The preferred filler is an inorganic material such as sand, talc, mica, slate, shale, limestone or fly, volcanic or bottom ash. The preferred filler is crushed limestone. Use of various materials can affect the resulting color of the shingle so selection of the filler can reduce the need for a colorant

The preferred composition includes a mixture of between 35 to 65% of the polymer component and 65-30% filler component. That mixture provides a lower weight and/or more flexible composite shingle. The preferred composition includes 60% crushed limestone and 40% polyethylene by weight.

The preferred roofing material is made by blending crushed limestone with polyethylene beads or pellets. The mixture is first fed into a mixer, preferably a kinetic mixer. The mixer not only blends the materials but also heats the material to a preferred state where the plastic encapsulates the filler. Color or other additives may be added at this stage. Once the material is mixed, it is conveyed to a piston type extruder and extruded out in shots. A typical shot will weigh between 30 and 35 pounds.

The blend is extruded onto the bottom platen of a mold. Once the material fills the bottom platen of the mold, the top platen of the mold is closed. Pressure is then applied to the top platen to compress the material to fill the entire mold. The preferred mold will be configured to have the shape of wood shakes, or the surface of slate. The preferred mold is approximately 16 feet by 12 inches. The material is cooled to form a board. That board is then cut to length and bundled in different sizes to be shipped.

The shape including the width, thickness contour and length of the shingle may be altered depending on the application. The preferred shingle shown in FIG. 1 will be 0.25 inches thick, 5 inches wide and 12 inches long, where one side is molded to simulate shake or slate. Color may be added to the mixture during processing or added later.

What is claimed is:

1. A composite roofing shingle comprising a mixture of:
a. about 36 to 64% polymer; and
b. about 36 to 64% filler.

2. A shingle according to claim 1 where the polymer is a polyolefin.

3. A shingle according to claim 1 where the polymer is polyethylene.

4. A shingle according to claim 1 where the filler is an inorganic material.

5. A shingle according to claim 1 where the filler is crushed limestone.

6. A roofing shingle:
a. that is less than an inch think;
b. between about 3-12 inches wide;
c. between about 6-24 inches long;
d. comprising at least about 36% polyolefin; and
e. comprising no more than about 64% filler.
